(19) United States
(12) Patent Application Publication
(10) Pub. No.: US 2019/0266554 A1
(43) Pub. Date: Aug. 29, 2019

(54) COGNITIVE REPLENISHMENT SYSTEM

(71) Applicant: International Business Machines Corporation, Armonk, NY (US)

(72) Inventors: Zhong-Hui Lin, Dublin, OH (US); Dean Phillips, South Lyon, MI (US); Kent R. VanOoyen, Greensboro, NC (US); Tao Liu, Dublin, OH (US); S. Kevin Daley, Atlanta, GA (US)

(21) Appl. No.: 15/907,856

(22) Filed: Feb. 28, 2018

(51) Int. Cl. G06Q 10/08; G06Q 30/02; G06Q 30/06; G06F 15/18

(52) U.S. Cl. CPC G06Q 10/087; G06Q 30/0202; G06F 15/18; G06Q 30/0633; G06Q 30/0631

(57) ABSTRACT

A method, computer program product, and a system where a process(s) generates a data model for a given environment; the model includes a listing of consumable items utilized in the environment and structured and unstructured data sources relevant to the consumable items utilized in the environment. The processor(s) machine learns factors related to supply and demand for the consumable items, based on ingesting structured and unstructured data from the data sources indicated in the data model and extracting occurrences of data representing consumable items coupled with occurrences of the factors. The processor(s) generates correlations quantifiable correlations between factors and consumable items and updates the model with the correlations. The processor(s) obtains, for a future time, a request for replenishment of the consumable items for the environment. The processor(s) uses the model to generate a replenishment plan for the environment for the given time period, based on ranking the consumable items.

### BACKGROUND

Anticipating needs and managing establishment (company, household, school, etc.) supply replenishment, which includes the replenishment of food and other consumable goods, is a common challenge. Many approaches are in situ solutions, which merely track an inventory at a given location and replenish the inventory based on usage. The goal of these approaches is to maintain a constant supply. These types of approaches prove static and are unable to adjust to changing needs. For example, a certain item may be in short supply in a given inventory because it is unavailable. Not only will replenishment be a challenge, but these systems provide no notice regarding this scarcity nor any solutions regarding how to mitigate this issue. Thus, automating these processes by anticipating changes, including the changes in the needs of a given population, which includes identifying and tracking factors that may affect the needs, is desirable.

### SUMMARY

Shortcomings of the prior art are overcome and additional advantages are provided through the provision of a method for generating an inventory replenishment plan for an environment. The method includes, for instance: generating, by one or more processors, a data model for a given environment, wherein the data model comprises a listing of consumable items utilized in the environment and structured and unstructured data sources relevant to the consumable items utilized in the environment; machine learning, by the one or more processors, factors related to supply and demand for the consumable items, based on ingesting structured and unstructured data from the data sources indicated in the data model and extracting occurrences of data representing consumable items coupled with occurrences of the factors; generating, by the one or more processors, correlations between one or more of the consumable items utilized and one or more of the factors, wherein the generating comprises assigning each correlation a quantifiable value; updating, by the one or more processors, the data model with the correlations; obtaining, by the one or more processors, for a future given time period, a request for replenishment of the consumable items for the environment; determining, by the one or more processors, an anticipated realization of the factors in the correlations, in the given time period, based on ingesting structured and unstructured data from the data sources indicated in the data model and extracting indicators of the factors in the correlations; ranking, by the one or more programs, the consumable items, based on the anticipated realization; and generating, by the one or more programs, a replenishment plan for the environment for the given time period, based on the ranking.

Shortcomings of the prior art are overcome and additional advantages are provided through the provision of a computer program product for generating an inventory replenishment plan for an environment. The computer program product comprises a storage medium readable by a processing circuit and storing instructions for execution by the processing circuit for performing a method. The method includes, for instance: generating, by one or more processors, a data model for a given environment, wherein the data model comprises a listing of consumable items utilized in the environment and structured and unstructured data sources relevant to the consumable items utilized in the environment; machine learning, by the one or more processors, factors related to supply and demand for the consumable items, based on ingesting structured and unstructured data from the data sources indicated in the data model and extracting occurrences of data representing consumable items coupled with occurrences of the factors; generating, by the one or more processors, correlations between one or more of the consumable items utilized and one or more of the factors, wherein the generating comprises assigning each correlation a quantifiable value; updating, by the one or more processors, the data model with the correlations; obtaining, by the one or more processors, for a future given time period, a request for replenishment of the consumable items for the environment; determining, by the one or more processors, an anticipated realization of the factors in the correlations, in the given time period, based on ingesting structured and unstructured data from the data sources indicated in the data model and extracting indicators of the factors in the correlations; ranking, by the one or more programs, the consumable items, based on the anticipated realization; and generating, by the one or more programs, a replenishment plan for the environment for the given time period, based on the ranking.

Methods and systems relating to one or more aspects are also described and claimed herein. Further, services relating to one or more aspects are also described and may be claimed herein.

Additional features are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 is an illustration of various aspects of an environment in which aspects of embodiments of the present invention may be implemented;

FIG. 2 is an illustration of certain aspects of an embodiment of the present invention;

FIG. 3 is a workflow illustrating certain aspects of an embodiment of the present invention;

FIG. 4 is a workflow illustrating certain aspects of an embodiment of the present invention;

FIGS. 5A-5B is an illustration of certain aspects of some embodiments of the present invention;

FIG. 6 is a workflow illustrating certain aspects of an embodiment of the present invention;

FIG. 7 is a workflow illustrating certain aspects of an embodiment of the present invention;

FIG. 8 is a workflow illustrating certain aspects of an embodiment of the present invention;

FIG. 9 depicts one embodiment of a computing node that can be utilized in a cloud computing environment;

FIG. 10 depicts a cloud computing environment according to an embodiment of the present invention; and

FIG. 11 depicts abstraction model layers according to an embodiment of the present invention.

### DETAILED DESCRIPTION

The accompanying figures, in which like reference numerals refer to identical or functionally similar elements throughout the separate views and which are incorporated in and form a part of the specification, further illustrate the present invention and, together with the detailed description of the invention, serve to explain the principles of the present invention. As understood by one of skill in the art, the accompanying figures are provided for ease of understanding and illustrate aspects of certain embodiments of the present invention. The invention is not limited to the embodiments depicted in the figures.

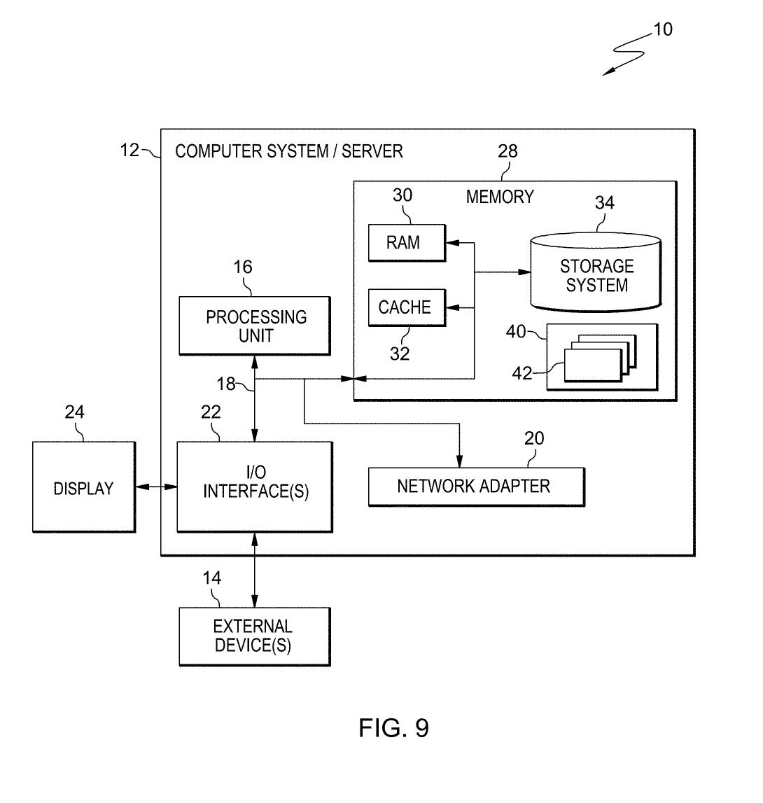

As understood by one of skill in the art, program code, as referred to throughout this application, includes both software and hardware. For example, program code in certain embodiments of the present invention includes fixed function hardware, while other embodiments utilized a software-based implementation of the functionality described. Certain embodiments combine both types of program code. One example of program code, also referred to as one or more programs, is depicted in FIG. 9 as program/utility 40, having a set (at least one) of program modules 42, may be stored in memory 28.

Embodiments of the present invention include a computer-implemented method, a computer program product, and a computer system for cognitive replenishment of items in a defined environment, physical or virtual (e.g., venue, household, organization, structure) where one or more programs executing on at least one processor: 1) generate and apply a multiple factor product analysis; and 2) generate a ranked shopping list (e.g., an inventory replenishment plan) utilizing the results of the cognitive factor analytics. In some embodiments of the present invention, the one or more programs: 1) identify sources within a vicinity (physical and/or virtual) of the environment from which to obtain data related to various consumable items utilized within the environment, including identifying the relevant items; 2) gather data from the identified variety of both structured and unstructured sources; 2) analyze and synthesize the data to ascertain usage patterns for various items, including determining factors that coincide with needs for replenishment of the various items, based on various parameters derived from the data and/or events internal to the data and/or external to the data; 3) generate a replenishment plan for the various items, which the one or more programs may utilize to order items (automatically) at established intervals. In some embodiments of the present invention, the one or more programs may establish the replenishment plan, which the one or more programs may executed, by ranking various products based on the analysis and time periods for replenishment derived by the one or more programs. The one or more programs may generate a list of the ranked products for review by a user. In some embodiments of the present invention, the data sources identified by the one or more programs and accessed by the one or more programs to obtain structured and unstructured data may include, but are not limited to, documents, files, texts, voice commands, voicemails, and/or pictures. In some embodiments of the present invention, the events that the one or more programs utilize when generating a replenishment schedule may include, but are not limited to, holidays, planned events, and/or predicted weather-related events. The one or more programs may be executed on various nodes of a distributed computing system, including but not limited to, a cloud computing system. Additionally, the data sources identified may also be computing nodes of a distributed computing system, including but not limited to, a cloud computing system.

The computer-implemented method, computer program product, and computer system comprise various embodiments of a multi-factor cognitive environmental replenishment system by executing one or more programs that analyze unstructured, internal and external data sources to define multiple factors to correlate to requirements for items, and rank items for replenishment. As will be discussed in greater detail herein, for each item, the one or more programs perform one or more of a product correlation factor analysis, a product ranking factor analysis, and/or a product safety factor analysis. The one or more programs additionally analyze a context of the scheduled events or other conditions from unstructured data sources to generate a replenishment/inventory plan based the extracted factors and how these factors correlate to needs for the items within a defined environment, as determined by the one or more programs.

Specifically, embodiments of the present invention include one or more programs executed on a processing circuit that ingest, compute and (machine) learn from various factors to produce an optimized inventory replenishment plan. In some embodiments of the present invention, the one or more programs automatically execute the optimized inventory replenishment plan. Although replenishment of consumable items in a defined environment, including but not limited to an individual household, is a known challenge, aspects of some embodiments of the present invention provide benefits over existing approaches to this challenge. These aspects not only distinguish embodiments of the present invention over existing solutions as being more efficient, effective, and/or comprehensive, these aspects of some embodiments of the present invention are also inextricably tied to computing. For example, in embodiments of the present invention, the one or more programs identify and process both structured and unstructured data (from a variety of data sources) to provide a multi-factor cognitive analytics, such as product correlation factor, product rank factor, and product safety factor, to aid in replenishment planning and eventual replenishment actions. The diversity of the data sources and the ability of the one or more programs to synthesize a variety of data enables the one or more programs to factor information into the analysis, including temporal data, which is synthesized in real-time in order to realize the impacts of the data in a manner that informs replenishment plans and subsequent actions. The temporal data included by the one or more programs in the cognitive analytics may include, but is not limited to weather, calendar, and event information. Based on the multi-factor analysis, in some embodiments of the present invention, the one or more programs provide predictive guides and other measures as the one or more programs anticipate upcoming needs for item replenishment, within given time periods, rather than alert to a replenishment needs for an item based on the current absence of the item (i.e., level monitoring).

Unlike existing approaches to replenishment within a given environment (physical or virtual), embodiments of the present invention are not merely inventory management systems that track items in a singular location, such as a store (e.g., in situ), but rather, embodiments of the present invention track replenishment needs for an individual and/or group of consumers, based on generating a data model that correlates factors, including factors experienced in the environment, with a quantified need for various items. Thus, rather than track inventory available for sale, embodiments of the present invention approach item replenishment from a consumer perspective. In personalizing the approach to replenishment, in some embodiments of the present invention, the one or more programs analyze unstructured data, including but not limited to, personal (or group) data available on social media, including pictures of the individual and/or group (e.g., as related to a relevant environment). From this data, the one or more programs generate a data model to correlate factors within the item to a level of need for items. The one or more programs reference the data model when generating a product recommendation, a product order, or other action included in the replenishment plan.

An advantage of embodiments of the present invention over present approaches to replenishing consumable items in a given environment is that embodiments of the present invention perform multi-factor cognitive analytics that enable one or more programs executed by at least one processing circuit in these embodiments to both determine and anticipate consumer-driven replenishment needs in a given environment. Rather than rely on inventory level monitoring or manual operation or feedback based on the inventory level monitoring, in embodiments of the present invention, one or more programs generate, obtain, and analyze, multiple factors as part of a cognitive analysis in order to anticipate changes in inventory plans in advance. These include, but are not limited to: 1) weather changes and the impact of these changes on an inventory plan, such as scarcity and/or increased costs (e.g., produce items during the winter), and/or anticipated greater consumption to mitigate weather changes (e.g., fire wood, coal, and/or other fuel for heating during the winter; 2) holidays and events surrounding the holidays that cause an environment to deviate from regular consumption patterns (e.g., hosting guests will impact the amount of food consumer in a given time period); 3) events not related to calendar holidays that cause an environment to deviate from regular consumption patterns (e.g., an annual sporting event in a given environment provides an occasion for hosting guests, who will consume more food and household products than the household members alone, in a given period); 4) events and/or holidays that cause scarcity and/or increased costs of items (e.g., a holiday characterized by the traditional consumption of certain foods creates scarcity and increased costs for these foods); 5) public and/or social media data related to foods safety (e.g., media reports of safety concerns with a given household product); and/or 6) public and/or social media data related to individual items (e.g., data may indicate a newer, cheaper, safer and/or otherwise better or alternative to an item that will require replenishment).

Embodiments of the present invention are inextricably tied to computing at least because the interconnectivity of distributed systems and data mining and processing techniques to access, analyze, and apply data from multiple sources, both structured and unstructured, is achievable only through the utilization of computing systems. In replenishment systems, analysis of needs and anticipation of needs is temporal and must be accomplished with consistency, over time, and, in many cases, in real time. The utilization of computing technologies enables the multi-factor cognitive analysis in embodiments of the present invention that result in the generation of replenishment plans with recommended items and/or automatic replenishment of consumable items in a virtual or physical environment.

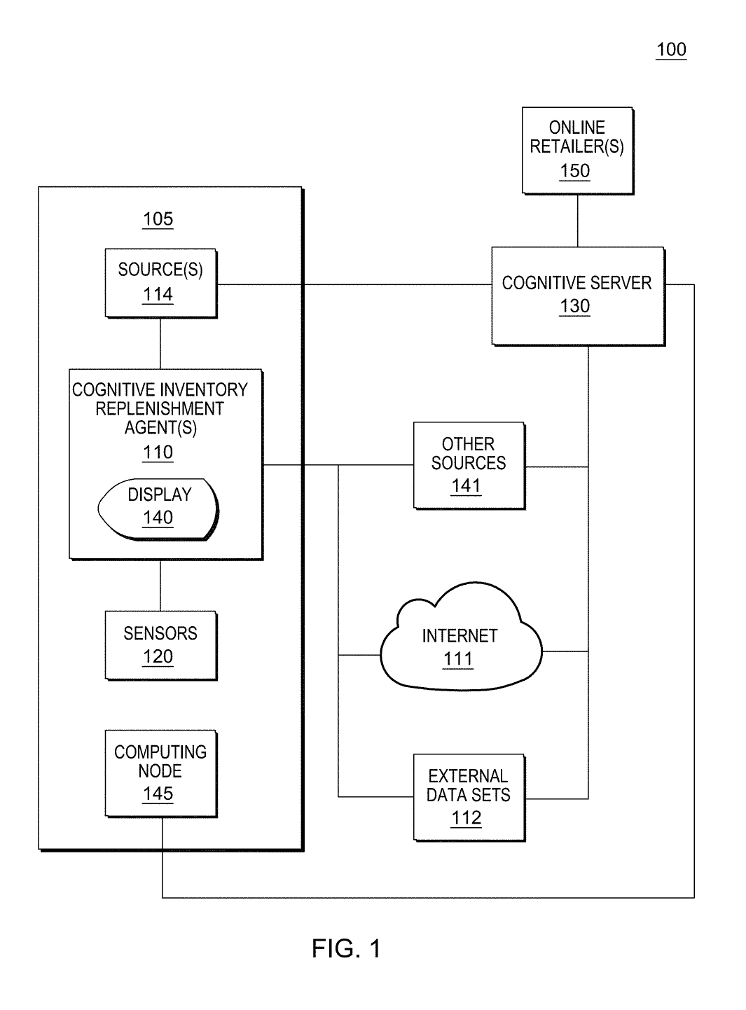

FIG. 1 is a technical environment 100 into which aspects of some embodiments of the present invention may be implemented. As will be discussed utilizing this environment 100 as a non-limiting example, in embodiments of the present invention, one or more programs perform a cognitive factor analysis to generate a replenishment plan and/or execute the plan in a temporal manner to timely replenish items for a given virtual and/or physical environment 105 (e.g., a physical household and/or a group of consumers in different physical locations who purchase and consume items as a household unit), including anticipating, in advance, various product needs, based on a cognitive multiple-factor analysis. As discussed above, certain embodiments of the present invention are based on consumer-driven needs and factors, rather than based on maintaining a static inventory from a producer (e.g., retailer, distributer, supplier, etc.) standpoint, at a given physical location (e.g., storeroom, store, warehouse, etc.). In embodiments of the present invention, one or more programs execute on one or more computing resources in order to obtain data, process data, and ultimately, generate and optionally, automatically implement, an inventory plan that serves to replenish consumable and items that require replenishment for other reasons (e.g., anticipated heightened need, expiration, etc.). In the technical environment 100 of FIG. 1, the computing resources that execute the one or more programs may include a cognitive server 130 and/or cognitive inventory replenishment agent(s) 110.

Referring to FIG. 1, certain of the data obtained and analyzed in various embodiments of the present invention is obtained by the one or more programs from one or more cognitive inventory replenishment agents 110 (e.g., smart appliances, installed household appliances, etc.). The cognitive inventory replenishment agent(s) 110 may include one or more Internet of Things (IoT) devices. As understood by one of skill in the art, the Internet of Things (IoT) is a system of interrelated computing devices, mechanical and digital machines, objects, animals and/or people that are provided with unique identifiers and the ability to transfer data over a network, without requiring human-to-human or human-to-computer interaction. These communications are enabled by smart sensors, which include, but are not limited to, both active and passive radio-frequency identification (RFID) tags, which utilize electromagnetic fields to identify automatically and to track tags attached to objects and/or associated with objects and people. Smart sensors, such as RFID tags, can track environmental factors related to an object, including but not limited to, temperature and humidity. The smart sensors can be utilized to measure temperature, humidity, vibrations, motion, light, pressure and/or altitude. IoT devices also include individual activity and fitness trackers, which include (wearable) devices or applications that include smart sensors for monitoring and tracking fitness-related metrics such as distance walked or run, calorie consumption, and in some cases heartbeat and quality of sleep and include smartwatches that are synced to a computer or smartphone for long-term data tracking. Because the smart sensors in IoT devices carry unique identifiers, a computing system that communicates with a given sensor can identify the source of the information. Within the IoT, various devices can communicate with each other and can access data from sources available over various communication networks, including the Internet.

In the technical environment 100, each cognitive inventory replenishment agent 110 may include a power source (e.g., a cognitive inventory replenishment agent 110 that is a household appliance may be powered through an outlet) and a communications connection over which the one or more programs may communicate with the agent 110 (e.g., wireless connectivity, Bluetooth, etc.). The cognitive inventory replenishment agent 110 may be a computing node, comprised of a combination of hardware and software, and may communicate with internal sensors 120 within the (virtual and/or physical) environment 105.

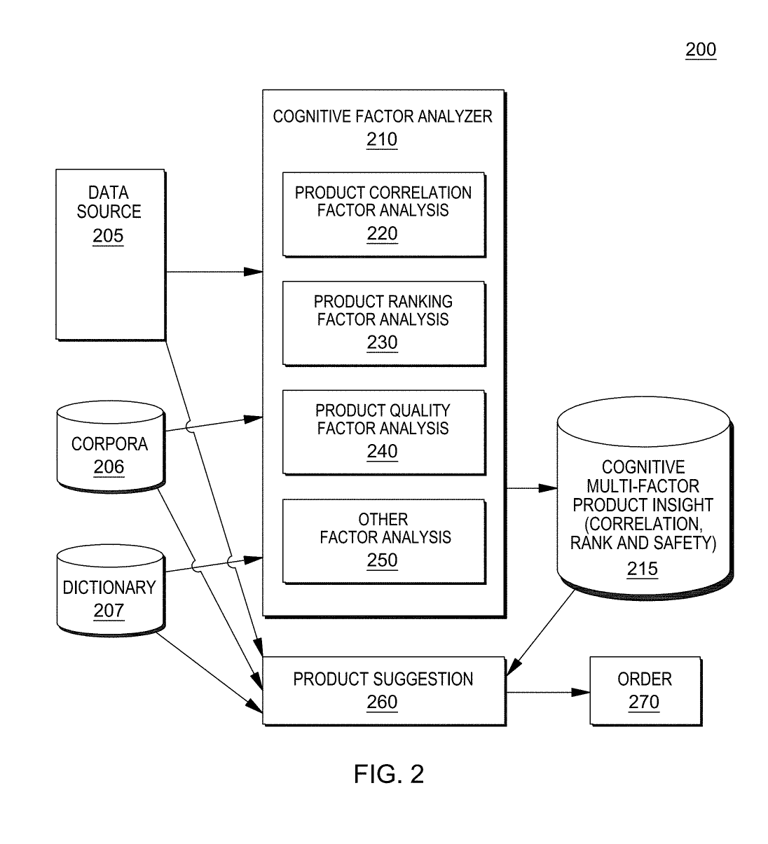

In some embodiments of the present invention, for a given environment 105, one or more programs executing on a processing resource of a cognitive inventory replenishment agent 110 capture and store item-related data for the environment 105 (e.g., food preferences data sets, sensor collected inventory level). Based on the communications connection, the one or more programs executing on the cognitive inventory replenishment agent 110 may also gather external data based on the items in the environment 105 that the one or more programs identify. In some embodiments of the present invention, the one or more programs capturing the item-related data for the environment 105 are executed by the cognitive server 130, which communicates with data sources within the environment 105, including but not limited to, one or more cognitive inventory replenishment agents 110. The one or more programs may access data related to the items that is publicly available (e.g., via the Internet 111 and other external datasets 112, and other sources 141). In some embodiments of the present invention, the cognitive inventory replenishment agent(s) 110 may include and/or interact with sensors 120 and event triggers, and based on receiving data via the sensors 120 or data that serves as triggers, based on a factor analysis that will be discussed in FIGS. 2-7. The cognitive inventory replenishment agent(s) 110 may communicate with a cognitive server 130, which can be inside and/or outside of the environment 105, in order to request data related to items, including but not limited to, requesting recommendations for replenishment of the given item, such as preferences accessible through data sources 114 within the environment 105. In some embodiments of the present invention, the cognitive inventory replenishment agent(s) 110 may include a display 140 in which a user may view a replenishment plan generated by one or more programs in an embodiments of the present invention, responsive, in part, to data received by the one or more programs from the cognitive inventory replenishment agent(s) 110 in the environment 105.

In some embodiments of the present invention, the one or more programs generate and transmit a purchase order to a cognitive inventory replenishment agent 110. A user may view and approve this purchase order through a display 140 on the cognitive inventory replenishment agent 110. Based on receiving an approval via an input/output coupled to the display 140 or integrated in the display 140, the one or more programs execute a purchase of items (e.g., via one or more ecommerce systems/websites), in accordance with the purchase order. In some embodiments of the present invention, the one or more programs automatically purchase items in accordance with the purchase order.

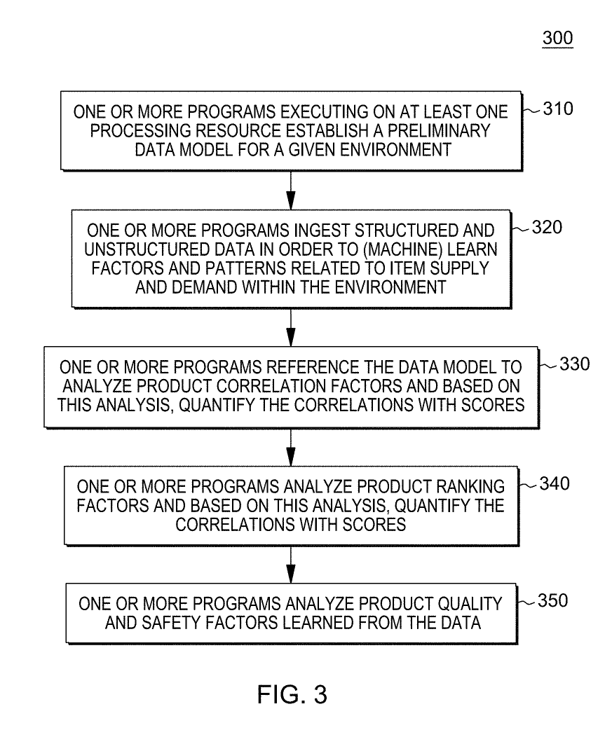

Returning to FIG. 1, in some embodiments of the present invention, the aforementioned cognitive server 130, may comprise one or more physical and/or virtual computing resources and may be part of a distributed computing environment, including but not limited to a cloud computing environment. One or more programs executing on the cognitive server 130 may obtain data from the cognitive inventory replenishment agent(s) 110 and integrate this data with data from various other sources (of both structured and unstructured data) 141 in order to generate and/or automatically implement, elements of an inventory management plan, including but not limited to, the aforementioned purchase order. To generate this plan, the one or more programs generate and/or comprise a data model structure to capture relationships between external events, environment 105 goods/items, and inventory strategy. The one or more programs utilize the data model structure to capture, for example, how external events impact current inventory strategy. The data model structure is a machine learning model/process that the one or more programs generate and update to continuously learn new relationships that affect will impact the inventory plan at anticipated points in the future, as well in a current time. As will be discussed in greater detail in FIGS. 2-3, the one or more programs utilize the data model structure to generate, recommend, and/or implement optimized inventory replenishment strategies.

In some embodiments of the present invention, the various other sources 141 that inform the model are accessed by the cognitive server 130 (i.e., the program code executing on the server) include data from social media, weather channels and other sources, news and media sites, event applications (e.g., personal and public calendars), various public data sources, and/or retailers associated with items in the inventory plan and/or items relevant to those items. The other sources may be external to the environment 105 and may include, but are not limited to, retailers, the United States Food and Drug Administration (FDA), social networks, weather data aggregators, event aggregators, financial institutions, and banks.

In some embodiments of the present invention, the one or more programs may monitor these sources 140 for the occurrence of specific (pre-defined) events, and at the occurrence of a given event (e.g., a snowstorm indicated by a weather source, an upcoming party on a calendaring application), the one or more programs update the data model structure and/or the inventory plan. As will be discussed in FIGS. 2-3, the occurrence of these pre-defined events impact the replenishment plan because during the cognitive analysis, the one or more programs identified these events as factors that correlate to demand for various items which will comprise the replenishment plan of the environment 105. In some embodiments of the present invention, the one or more programs obtain pre-defined (targeted) events from the sources 140 to utilize with the data model (which correlates the recognized factors, indicated by the events, with one or more items) in order to generate and/or update an inventory plan.

In some embodiments of the present invention, the one or more programs executing on the cognitive server 130 may provide a user associated with the environment 105, through a computing node 145, with a recommendation for how to meet a replenishment need identified by the cognitive server 130. For example, the cognitive server 130 may identify a need for a product but may ascertain from retailer data available from the sources 140 that the product is not available in the immediate geographic vicinity of the environment 105. Based on the nature of the product and additional external data from the sources 140, the one or more programs may determine that obtaining the product from a retailer outside of the geographic vicinity of the environment 105 is not practical. For example, the item may be perishable and the one or more programs may determine that because the outdoor temperature will not allow for the preservation of the product from the retailer to the environment 105. The one or more programs may determine that consuming the item after this trip will be unsafe. Thus, when the user requests a recommendation for how to fulfill the need for the unavailable product, rather than suggest obtaining the product at a retailer outside of the vicinity, the one or more programs may utilize external data from the source 140 to identify a similar product that is available within the vicinity.

In some embodiments of the present invention, the user, through a computing node 145, may provide the cognitive server 130 with various constraints for a request, including but not limited to, product preferences, geographic locations, etc. The cognitive server 130 may utilize these preferences to update the model and utilize the model to provide a recommendation to meet the request and/or automatically purchase a product that meets the criteria defined by the user in the request.

In some embodiments of the present invention, the one or more programs may generate the inventory plan in part based on attributes of the environment 105 that can also be understood as preferences of the consumers who comprise the environment 105. The one or more programs executed by the cognitive server 130 may obtain preference information from the cognitive inventory replenishment agent(s) 110 and the other sources 140 that the one or more programs utilize when generating an inventory plan.

As discussed above, the one or more programs, executed by one or more of the cognitive server 130 and/or cognitive inventory replenishment agent(s) 110 may automatically make purchases based on the inventory plan generated by these one or more programs. For example, the one or more programs may communicate with online retailers 150 in order to place these orders. In a situation where the one or more programs determine that certain items designated in an inventory plan are not available for an online provider, or are preferred from a brick and mortar location for a reason determined utilizing the data model (e.g., personal preferences learned by the data model), the cognitive server 130 may generate a shopping list that designates both items and brick and mortar locations where they can be purchased. The cognitive server 130 transmits this list to one or more of the computing node 145 or a cognitive inventory replenishment agent 110, for display to a user.

FIG. 2 illustrates various aspects of some embodiments of the present invention, specifically, the cognitive factor analysis performed by one or more programs. As aforementioned in reviewing FIG. 1, in embodiments of the present invention, one or more programs, referred to in FIG. 2 as a cognitive factor analyzer 210, obtain data from various sources within a given environment in order to generate an inventory plan. As illustrated in FIG. 2, the inventory plan generated by some embodiments of the present invention includes one or more product suggestion 260.

As illustrated in FIG. 2, one or more programs of the cognitive factor analyzer obtain 210 data from various sources 205 relevant to a given environment (e.g. FIG. 1, 105). In some embodiments of the present invention, the one or more programs may obtain data from one or more cognitive inventory replenishment agents (e.g., FIG. 1, 110), and/or other computing nodes within the environment (e.g., FIG. 1, 105) or personal to consumers that comprise the environment, including but not limited to, IoT devices. The one or more programs may also solicit this information from consumers who comprise the environment (e.g., FIG. 1,105), for example, through a computing node (e.g., FIG. 1, 145) or a display (e.g., FIG. 1, 140) of a cognitive inventory replenishment agents (e.g., FIG. 1, 110).

Based on obtaining the data from the various sources 205, the cognitive factor analyzer 210 establishes a data model for the given environment (e.g. FIG. 1, 105). The data model may be comprised of an environment corpora 206 and an environment dictionary 207. The environment corpora 206 define the a collection of data sources 205 that the cognitive factor analyzer 210 locates and can continually reference for data relevant to items utilized within the environment. The environment dictionary 207 defines relationships between items and factors adjudged relevant by the cognitive factor analyzer 210.

The cognitive factor analyzer 210 establishes the environment dictionary 207 and the environment corpora 206. The environment dictionary 207 and the environment corpora 206 can be understood as an initial data model that reflects preferences of consumers in a given physical or virtual environment (e.g., FIG. 1, 105). The cognitive factor analyzer 210 trains the initial data model utilizing both structured and unstructured data sets relevant to the environment (e.g., FIG. 1, 105), including from the data sources 205, as compiled in the environment corpora 206. The environment corpora 206 may include data accessible from source both within and outside of the environment (e.g., FIG. 1, 105). The data from various sources 205, denoted in the environment corpora 206, may include data that is relevant to the consumers who comprise the environment (e.g., FIG. 1, 105), including but not limited to, inventor status, preferences, calendars (events), memberships (e.g., memberships to certain retail establishments may affect the pricing and quantity of available items). The data from various sources 205 also include sources (e.g., FIG. 1, 140) that are external to the environment (e.g., FIG. 1, 105), including but not limited to retailers, the FDA, social networks, weather data aggregators, event aggregators, financial institutions, banks, and/or other publicly available sources of data relevant to items that will be part of a replenishment plan generated by the one or more programs. In some embodiments of the present invention, in order to digest the structured and unstructured data to train the initial model, the cognitive factor analyzer 210 utilizes both machine learning algorithms and natural language processing.

As depicted in FIG. 2, in order to generate a product suggestion 260 for a given product that is part of the replenishment plan generated by the cognitive factor analyzer 210 in some embodiments of the present invention, the cognitive factor analyzer 210, referencing the environment corpora 206 and an environment dictionary 207 (i.e., the initial data model established and trained by the one or more programs for the given environment). As will be discussed later herein, the cognitive factor analyzer 210 performs a factor-based analysis to produce a replenishment plan, including individual product recommendations (recommendations may identify the product as well as the timing in which the product should be purchased). Certain of the analyses performed by the cognitive factor analyzer 210 include, but are not limited to product correlation factor analysis 220, product ranking factor analysis 230, and/or product quality factor analysis 240. The cognitive factor analyzer may also perform one or more other factor analysis 250. In the product correlation factor analysis 220, the cognitive factor analyzer 210 determines data that could trigger a need or a change in need for a given item (product). In the product ranking factor analysis 230, the cognitive factor analyzer 210 quantifies the importance of replenishment of a given product, in view of factors identified in the data. In the product quality factor analysis 240, the cognitive factor analyzer 210 determines the priority of items (products) based on evaluating the quality of the items, based on the data. For example, an item that is derided on social media as being of poor quality, may not be recommended in a product suggestion 260 by the cognitive factor analyzer 210 as part of a replenishment plan. As depicted in FIG. 2, the cognitive factor analyzer 210 produces a cognitive multi-factor product insight 215, based on the analyses related to correlation, rank and/or safety (e.g., accessing FDA data). The cognitive factor analyzer 210 applies the cognitive multi-factor product insight 215 for each product suggestion 260. Based on the product suggestion 260, the one or more programs may automatically order 270 and/or generate a purchase order, for a recommended product.

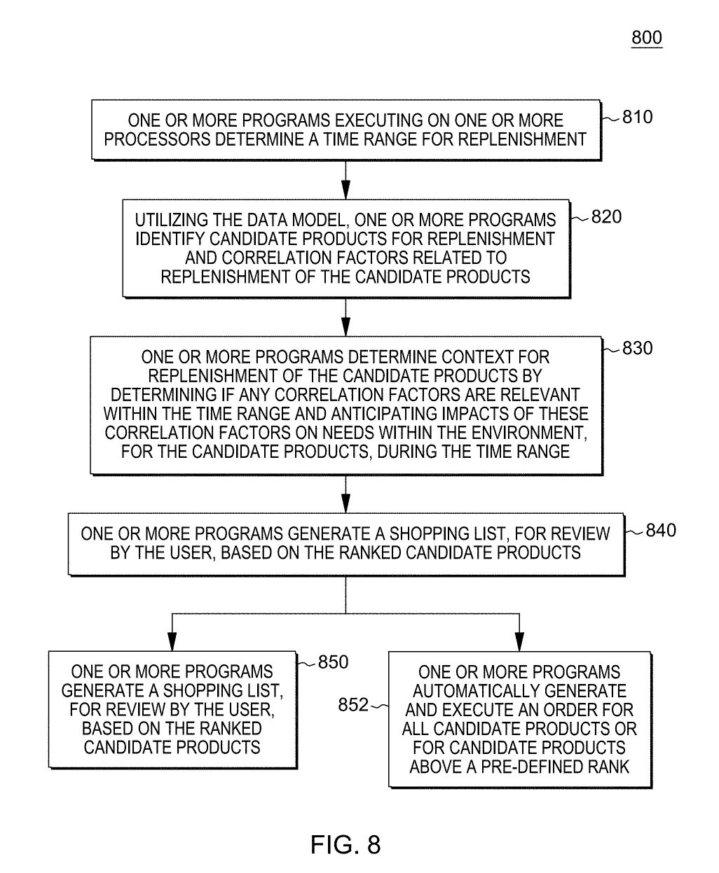

As discussed above, aspects of some embodiments of the present invention can be understood as two distinct aspects, each aspect with sub-aspects. In a broad sense, in the first aspect, one or more programs perform a multiple factor analysis. In the second aspect, the one or more programs generate an inventory replenishment plan based on this analysis. In some embodiments of the present invention, the inventory replenishment plan comprises a ranked shopping list with cognitive context factor analytics. FIGS. 3-7 illustrate various sub-aspects of the first aspect (i.e., performing multiple factor analysis), while FIG. 8 illustrates various sub-aspects of the second aspect (i.e., generating an inventory replenishment plan), as performed by one or more programs executed on at least one processing resource, in various embodiments of the present invention.

FIG. 3 is a workflow 300 that illustrates certain aspects of some embodiments of the present invention. In particular, the workflow 300 illustrates certain functionality of the one or more programs referred to the cognitive factor analyzer (e.g., FIG. 2, 210). FIG. 3 is a general or summary workflow 300 and certain aspects of this workflow 300 will be discussed in greater detail subsequently. As discussed in FIG. 2, in some embodiments of the present invention, one or more programs (i.e., cognitive factor analyzer) executing on at least one processing resource establish a preliminary data model for a given environment, which includes, a dictionary and corpus for items or retail products utilized within the given environment (310). The corpus references data sources within the environment (or relevant to the environment), which the one or more programs may draw data from in order to generate a replenishment plan. After having established the preliminary data model, the one or more programs ingest structured and unstructured data in order to (machine) learn factors and patterns related to item supply and demand within the environment (320).

The one or more programs perform a multi-factor cognitive analysis in order to generate a replenishment plan that includes various item/product recommendations. As part of this analysis, the one or more programs reference the data model to analyze product correlation factors and based on this analysis, quantify the correlations with scores (330). The one or more programs may also analyze product ranking factors and based on this analysis, quantify the correlations with scores (340). The one or more programs may also analyze product quality and safety factors learned from the data (350). Based on the results of the multi-factor cognitive analysis, the one or more programs make one or more product suggestion, aspects of which are illustrated in FIG. 8. As will be discussed in FIG. 8, in some embodiments of the present invention, the one or more programs generate a ranked shopping list with results of the cognitive context factor analytics in FIG. 3.

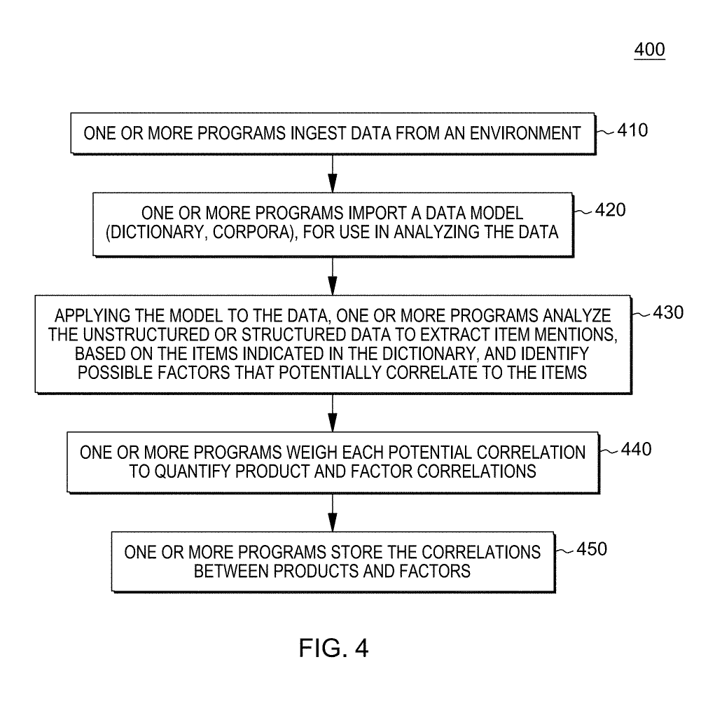

FIG. 4 is a workflow 400 that further illustrates the aspect of FIG. 3 where the one or more programs reference data model to analyze product correlation factors and based on this analysis, quantify the correlations with scores (e.g., FIG. 3, 330). To analyze product correlation factors, the one or more programs (e.g., FIG. 2, cognitive factor analyzer 210) ingest (continuously, on demand, and/or at pre-determined intervals) data from the environment (e.g., FIG. 1, a given virtual and/or physical environment 105) (410). The ingested data may include, but is not limited to, unstructured documents and files, including texts, voice messages, pictures, etc. The data sources may include cognitive agents within the environment, IoT devices associated with individuals who are part of the environment, social media postings of individuals who are part of the environment, etc. The one or more programs import the data model (e.g., the aforementioned dictionary and corpora), for use in analyzing the data (420). As the one or more programs may utilize the corpora to locate the data to ingest, aspects 410 and 420 may be executed simultaneously, in some embodiments of the present invention. Alternatively, the one or more programs may refer to the corpora to determine if the one or more programs have tapped all potential data sources for potential product data. Applying the model to the data, the one or more programs analyze the unstructured or structured data (e.g., files documents, photos) to extract item mentions, based on the items indicated in the dictionary, and identify possible factors that may correlate to the items (430).

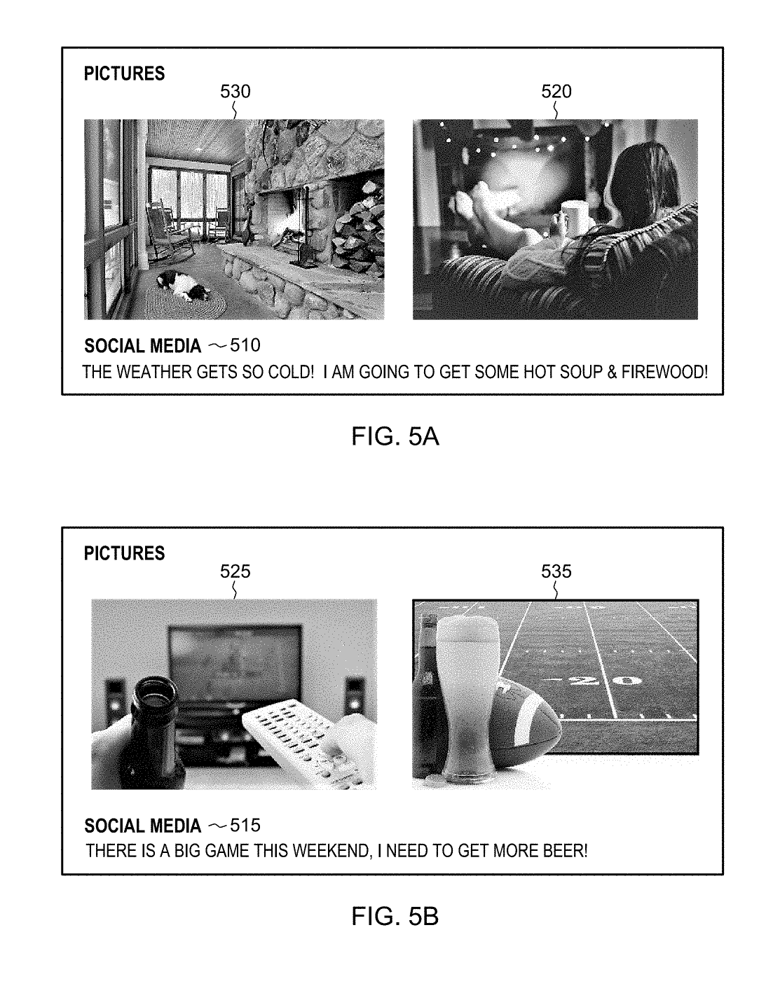

FIGS. 5A-5B illustrate the one or more programs applying the model to the data and analyzing a data source to extract item mentions to identify possible factors that may correlate to the items (FIG. 4, 430). The correlation factors illustrated in FIGS. 5A-5B are a type of weather and a type of event. These examples are offered for illustrative purposes only, as there are arguably an infinite amount of factor types that various embodiments of the present invention may recognize are correlating to various items, including demand for the items.

Referring first to FIG. 5A, pictures and a social media posting are visually aggregated to demonstrate how the one or more programs extract product and weather correlations from, in this example, unstructured data. As seen in FIG. 5A, a social media post by an individual associated with an environment includes the statement 510, “The weather gets so cold! I am going to get some hot soup & firewood!” Based on natural language processing, and correlating the items “soup” and “firewood” from the pre-established dictionary of products/items utilized in the environment, the one or more programs identify a correlation between cold weather and the products firewood and soup. FIG. 5A also includes two pictures 520 530, posted in this example by the individual to social media, that a first picture 520 of include an individual drinking something hot by a fireplace, where firewood is burning, and a second picture 530 of a fireplace with firewood stacked up. Thus, FIG. 5A demonstrates how one or more programs in an embodiment of the present invention establish a possible correlation between a factor, in this case, weather, and one or more items, in this example, firewood and soup.

FIG. 5B illustrates how one or more programs in an embodiment of the present invention recognize an event as a correlation factor for particular products, in tis example, beer (a common alcoholic beverage consumed during sporting events) and chips. The post 515 on social media in 5B states, “There is a big game this weekend, I need to get more beer!” Additionally, on s social media account associated with an individual within the environment, two pictures 525 535 were posted. The images show an individual consuming beer while watching a sporting event on television 525 and beer in front of a football field 535. In this example, the second image 535 is assumed to be from a posting on social media, however, data sources accessed to identify factors that correlate to products are not limited to social media. The second image 535 may also be a screen capture from a smart television (IoT device) from which data is obtained by the one or more programs in some embodiments of the present invention. The one or more programs in an embodiment of the present invention can recognize a possible correlation between an upcoming sporting event and foods and beverages that the data indicates are consumed within the environment when there is a viewing of a sports event.

Upon identifying factors that seemingly correlate to products, the one or more programs weigh each potential correlation to quantify product and factor correlations (440). In some embodiments of the present invention, the one or more programs determine the weight (i.e., strength) of a given potential correlation, between a factor and a product/item, by calculating a number of the co-appearances of the given product and candidate factor mentions in the data. In addition to counting the number of appearances, the one or more programs may assign a weight to an appearance of an item with a potentially correlated factor, by degree of relation. For example, in a photograph that includes the item and the factor, the one or more programs may determine that a correlation is stronger based on the distance between the pictured item and the pictured factor, in the photograph. In some embodiments of the present invention, the one or more programs store learned correlations, based on the weights of the potential correlations meeting a threshold, as part of the data model (e.g., in the dictionary or corpora).

Tables 1 and 2 below demonstrates how some embodiments of the present invention weigh the correlation of factors with items. Table 1 demonstrates the evaluation of the aforementioned weather and product correlation (e.g., firewood and soup with cold weather), while Table 2 demonstrates the evaluation of a correlation between an event type and product (e.g., televised sporting event and beer and chips).

Referring to Table 1, as depicted below, the one or more programs determines a higher weight for the correlation of snow to firewood, than heat to firewood. The one or more programs also determine a higher demand, or probability of demand, for soup in the event of snow, than during a heat wave. The need for ice cream and salad is higher in the heat than in the cold.

TABLE 1

| Correlation Factor (Weather) | Snow | Heat |
|---|---|---|
| Firewood | +80 | −90 |
| Soup | +50 | Neutral |
| Ice Cream | −60 | +80 |
| Salad | −30 | +50 |

Table 2 below demonstrates how one or more programs may quantify or rank the correlation between external events, in this case, a football game, and Halloween, and various items, including chips, beer, pumpkins, and candy. Table 2 demonstrates how in some embodiments of the present invention, the one or more programs analyze correlations by calculating the co-appearance of a given product and a candidate factor in records in the data, for example, by degree of related distances. Table 2 reveals a higher correlation (or need) for beer and chips in the event of a football game and a lower correlation on Halloween. Meanwhile, Halloween is a factor (event-based) that raises need for pumpkins and candy.

TABLE 2

| Correlation Factor (Event) | Football Game | Halloween |
|---|---|---|
| Chips | +40 | +30 |
| Beer | +70 | +30 |
| Pumpkin | neutral | +90 |
| Candy | neutral | +70 |

Returning to FIG. 4, the one or more programs store the correlations between products and factors (450). In some embodiments of the present invention, the one or more programs may evaluate the correlations between products and factors and store those that surpass a given threshold. In some embodiments of the present invention, the one or more programs may quantify the correlations with scores and may store the resultant scores. The stored correlations effectively become a part of the data model that the one or more programs may utilize in generating and inventory plan. Specifically, the factors that are correlated to products become triggers for ultimately defining a product and a quantity of the product in a replenishment plan during a given temporal period. For example, if a stored correlation has a highly weighted event-based correlation between ice cream and the 4^{th} of July, the one or more programs, when the one or more programs ingest data from the environment (410), the one or more programs may parse the data for indicators relevant to the 4^{th} of July, a factor in the retained correlation. Among the data sources may be a social media post that states, “I am so excited for the 4^{th}! What a great day we have planned.” The one or more programs may parse this social media post and extract the “4^{th}” mention and make adjustments to an inventory plan based on the saved correlation between this event and the item ice cream.

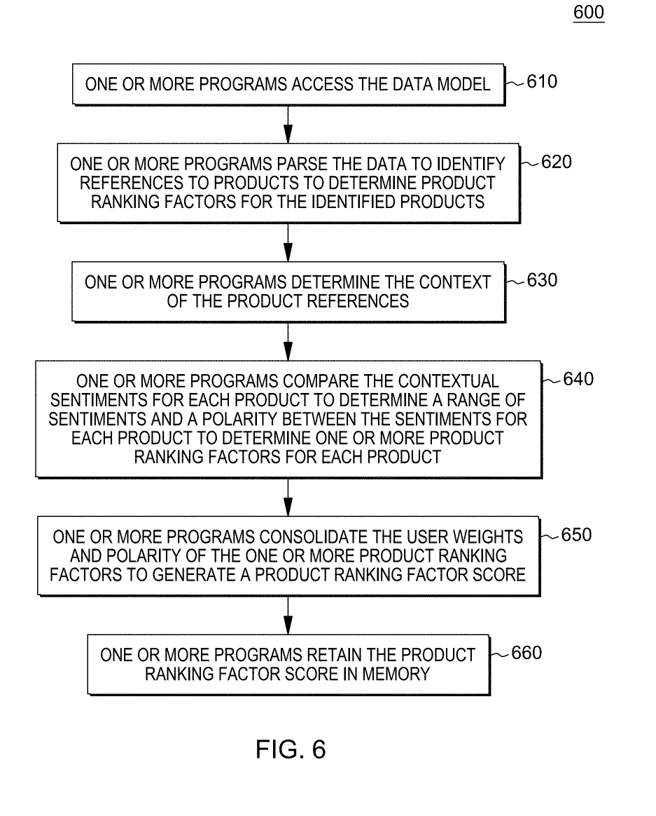

FIG. 6 is a workflow 600 that further illustrates the aspect of FIG. 3 where the one or more programs reference data model to analyze product ranking factors and based on this analysis, quantify the correlations with scores (e.g., FIG. 3, 340). The product ranking includes integrating user weights and polarity into rankings that are eventually reflected in the inventory replenishment plan. In embodiments of the present invention, the one or more programs access the data model, which includes the environment corpus (mapping locations and accessibility of structured and unstructured data sources), the domain dictionary, which identifies products relevant to the replenishment of the environment, and the retained correlations (e.g., FIG. 4, 450) (610). In some embodiments of the present invention, accessing the initial data model includes loading the dictionary, corpora, and sources (e.g., source documents) indicated in the corpora. The one or more programs parse the data (which is located utilizing the corpora) to identify reference to products (defined in the dictionary), to determine product ranking factors for the identified products (620). Product ranking factors refer to qualities by which various products may be ranked, including but not limited to quality, price, taste, etc.

The one or more programs determine the context of the product references (630). In some embodiments of the present invention, the one or more programs utilize natural language processing in order to make these determinations. The one or more programs compare the contextual sentiments for each product to determine a range of sentiments and a polarity between the sentiments for each product to determine product ranking factors for each product (640). In some embodiments of the present invention, to establish the user sentiments, the one or more programs determine user weights for each product based on sentiments expressed regarding the product as related to various aspects of the product. Product ranking factors include various factors that are utilized to characterize and/or rate the product.

By analyzing product ranking factors, one or more programs in embodiments of the present invention can potentially recommend a product that is a competitor of a product that was formerly in an inventory plan, or referenced in a dictionary, should the one or more programs determine that user weights and polarity indicate that the competitor product is a better choice to meet a perceived need. For example, when the one or more programs parse the data to identify reference to products, and extract the product ranking factors for the identified products (620), the one or more programs may identify statements among the data sources such as the examples below, which speak to a Product X, which was referenced in the dictionary, comparing it to the Product Y, that may not be referenced in the dictionary. The one or more programs extract the following reference to Product X: 1) “Product X does not taste as good as it usually does. Try Product Y instead! The taste of Product Y is better at the same price!” and 2) “Product X's quality is not as good as usual. Try Product Y instead! The quality of Product Y is better at the same price!” The references may be on a social media page belonging to a user who consumes products in the environment. The references may also be from a public source, for example, an advertising campaign that is trending. In this example, the one or more programs determine the context of the product references (630) by identifying the references to the products (i.e., X and Y), identifying the sentiment expressed (i.e., “not as good”) and identifying the factor of the product that is being comments upon (i.e., taste and quality).

Returning to FIG. 6, the one or more programs consolidate the user weights and polarity (discrepancies between various comments in order to calculate a centered aggregate) of the one or more product ranking factors to generate a product ranking factor score (650). Table 3 below provides a simplified example of the one or more programs generating a product factor ranking score. As understood by one of skill in the art, the factors that can be identified and utilized in embodiments of the present invention are expansive and can be identified by the one or more programs by utilizing the environment dictionary to extract terms and images in unstructured data that are proximate to the item identifiers from the dictionary.

TABLE 3

| Product Ranking Factor | Taste | Price | Appearance | Shipping |
|---|---|---|---|---|
| User Weights | 5 | 3 | 4 | 2 |
| Product X | +10 (Article | −5 | +10 | −6 |
| | 10) | | | |
| Product Y | +20 | +9 | +15 | +11 |

Table 4 shows resultant product ranking factor scores, based on the processing of the one or more programs. The one or more programs retain these scores in memory (660). In some embodiments of the present invention, these scores are stored as part of the data model that is applied when formulating subsequent inventory replenishment plans and actions (e.g., generating a shopping list, making an automatic purchase, making a recommendation).

TABLE 4

| | Product Ranking Factor Score |
|---|---|
| Product X | +63 |
| Product Y | +209 |

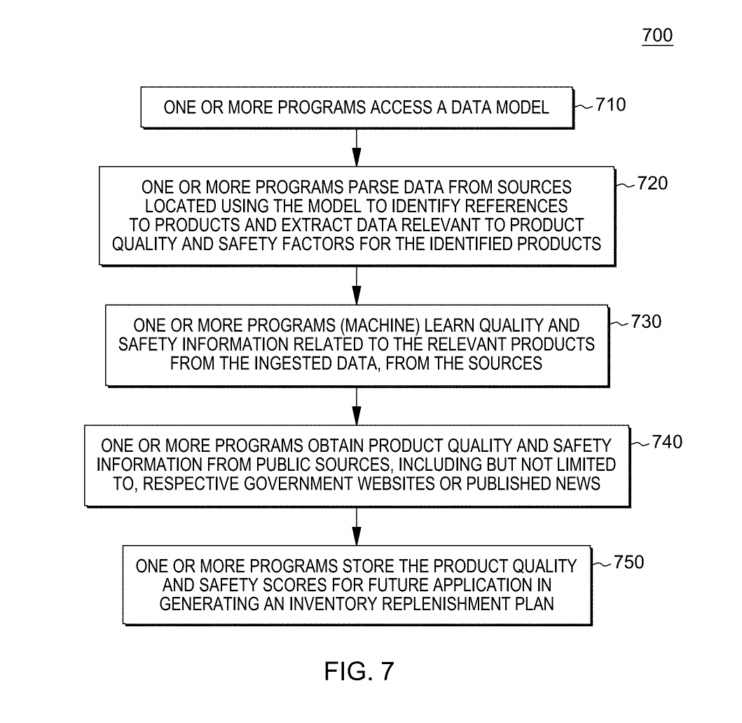

FIG. 7 is a detailed depiction of some sub-aspects of the one or more programs analyzing product quality and safety factors learned from the data (e.g., FIG. 3, 350) in order to produce an inventory replenishment plan (or to execute an action related to the plan, including but not limited to, making a product recommendation and/or automatically fulfilling a product need). In embodiments of the present invention, the one or more programs access the data model, which includes the environment corpus (mapping locations and accessibility of structured and unstructured data sources), and the domain dictionary, which identifies products relevant to the replenishment of the environment (710). Depending upon the ordering of the various analyses in the method, the data model may also include the retained correlations and the product ranking factor scores. The one or more programs parse the data (which is located utilizing the corpora) to identify references to products (defined in the dictionary), and extract data relevant to product quality and safety factors for the identified products (720). The one or more programs (machine) learn quality and safety information related to the relevant products from the ingested data, from the sources, which may include both structured and unstructured data, such as documents and files (730). The learned information provides the one or more programs with a framework to use when evaluating whether a given product is safe. For example, the one or more programs may learn that a consumable food is safe for three weeks after it is purchased, provided it is refrigerated for the duration. The one or more programs may also learn about the company that manufactures a given product and what the product is made of, which will help in identifying relevant safety standards. For example, the one or more programs may obtain the name of a given toy from the dictionary. Based on the data obtained from sources referenced in the corpora, the one or more programs may learn that the toy is made from plastic and is manufactured by a given company. In another example, upon obtaining “milk” as a product from the dictionary, based on data accessed with the assistance of the corpora, the one or more programs may learn that the specific milk referenced in the dictionary is distributed by a given organization and packaged in plastic bottles manufactured by another organization. This information is useful when the one or more programs parse public information (740), to locate, for example, any recall notices.

Returning to FIG. 7, to supplement the data accessed via the corpora, the one or more programs obtain product quality and safety information from public sources, including but not limited to, respective government websites or published news (740). In some embodiments of the present invention, the data parsed may include, but is not limited to, social media posts, government websites, and retailer websites. The one or more programs may perform searches for publicly available data related to the products or items in the dictionary and may update the corpora as more sources are located so that these sources will be referenced by the one or more programs in the future. Table 5 provides an example of data that may be available publicly related to a product references in the dictionary. In this example, the product is milk, but there are different options for brands that the dictionary indicates that the environment will accept. Thus, the one or more programs obtains data regarding the bacteria count (a safety factor) for each brand.

TABLE 5

| Brand | Bacterial Count |
|---|---|
| Brand X | Qualified |
| Brand Y | Unqualified |
| Brand Z | Unqualified |

Based on the processed data from obtained via the data model and the public sources, the one or more programs quantify the product quality and safety factor(s) for each product to generate a product quality and safety score (750). The one or more programs can utilize the score to compare various products that may meet the same perceived need in an inventory replenishment plan. Table 6 provides an example of scoring that the one or more programs determine for various products that may be included in an inventory replenishment plan for a given environment. Table 6 provides scores for products that the environment dictionary indicates are utilized in the environment.

TABLE 6

| Product Quality & Safety Factor | Qualification Score |
|---|---|
| Milk “Y” | −40 |
| Egg A | +10 |
| Ice Cream B | +40 |
| Beef C | +5 |
| Pork D | +8 |

The one or more programs store the product quality and safety scores for future application in generating an inventory replenishment plan (760). These factors may be stored by the one or more programs as part of the data model. In some embodiments of the present invention, the values assigned to evaluate safety of product may be binary, thus, the one or more programs determine that a product is either safe or unsafe.

Based on the results of the multi-factor cognitive analysis, of which examples are illustrated in FIGS. 3-7, the one or more programs make one or more product suggestion, aspects of which are illustrated in FIG. 8. FIG. 8 depicts a workflow 800 where the one or more programs, in some embodiments of the present invention, generate a ranked shopping list with results of the illustrated and described cognitive context factor analytics. Generating a shopping list may be triggered, based on a scheduled job, or may be triggered based on the one or more programs monitoring inventory in an environment (e.g., FIG. 1, 105), for example, by obtaining inventory data from one or more cognitive inventory replenishment agent (e.g., FIG. 1, 110) within the environment (e.g., FIG. 1, 105).

In some embodiments of the present invention, one or more programs executing on one or more processors determine a time range for replenishment (810). In some embodiments of the present invention, the range may be pre-defined. In some embodiments of the present invention, the one or more programs may determine a range based on shopping history. The one or more programs may also determine the range based on determining a need for a threshold number of products. Utilizing the data model (e.g., the data dictionary), the one or more programs identify candidate products for replenishment and correlation factors related to replenishment of the candidate products (820).

The one or more programs determine context for replenishment of the candidate products by determining if any correlation factors (e.g., event, holiday, weather, etc.) are relevant within the time range and anticipating impacts of these correlation factors on needs within the environment, for the candidate products, during the time range (830). In some embodiments of the present invention, the one or more programs determine the context based on the time range and/or the location of the environment. For example, based on the time range being a week, the one or more programs may determine that the weather will be cool for one or more days and hot and sunny for the remainder, two basketball games will be televised, and a gathering is planned around viewing one of the games. The one or more programs determine whether these factors correlate with the candidate item and adjust anticipated need for these items within the time range based on these factors.

The one or more programs rank the candidate products based on the context, product ranking factor score, and product ranking safety score (840). In some embodiments of the present invention, one or more of these scores in not available. However, the one or more programs may rank the candidate products based on the cognitive analytics available in the data model. Table 7 is an example of a consolidation of candidate product rankings based on various cognitive factors, including factors related to the aforementioned correlations and product safety.

TABLE 7

| | | | | | Attendee |
|---|---|---|---|---|---|
| Item | Weather | Event | Rating | Safety | Relationship |
| Beer A | −0.001 | 0.9 | 0.3 | 0.9 | 0.2 |
| Beer B | −0.001 | 0.9 | 0.9 | 0.9 | 0.9 |
| Ice Cream C | 0.9 | 0.7 | 0.8 | 0.9 | 0.8 |
| Prod D | −0.9 | 0.1 | 0.5 | 0.1 | 0.6 |

In some embodiments of the present invention, the one or more programs revise the ranks of the candidate products, based on cognitive analytics, with other factors from one or more historical shopping list, personal preferences indicated by the user, etc.

In some embodiments of the present invention, the one or more programs generate a shopping list, for review by the user, based on the ranked candidate products (850). In some embodiments of the present invention, the one or more programs include, in the shopping list, only candidate products above a certain rank. Table 9 is an example of a partial final shopping list generated by one or more programs in an embodiment of the present invention.

TABLE 9

| | | | | | Attendee |
|---|---|---|---|---|---|
| Item | Weather | Event | Rating | Safety | Relationship |
| Beer A | −0.001 | 0.9 | 0.3 | 0.9 | 0.2 |
| Beer B | −0.001 | 0.9 | 0.9 | 0.9 | 0.9 |
| Ice Cream C | 0.9 | 0.7 | 0.8 | 0.9 | 0.8 |
| Prod D | −0.9 | 0.1 | 0.5 | 0.1 | 0.6 |

In other embodiments of the present invention, the one or more programs automatically generate and execute an order for all candidate products or for candidate products above a pre-defined rank (852).

Embodiments of the present invention include a computer-implemented, a computer program product, and a computer system, where one or more programs, executed by at least one processor, generate a data model for a given environment, where the data model includes a listing of consumable items utilized in the environment and structured and unstructured data sources relevant to the consumable items utilized in the environment. The one or more programs machine learn factors related to supply and demand for the consumable items, based on ingesting structured and unstructured data from the data sources indicated in the data model and extracting occurrences of data representing consumable items coupled with occurrences of the factors. The one or more programs generate correlations between one or more of the consumable items utilized and one or more of the factors, where the generating includes assigning each correlation a quantifiable value. The one or more programs update the data model with the correlations. The one or more programs obtain, for a future given time period, a request for replenishment of the consumable items for the environment. The one or more programs determine an anticipated realization of the factors in the correlations, in the given time period, based on ingesting structured and unstructured data from the data sources indicated in the data model and extracting indicators of the factors in the correlations. The one or more programs rank the consumable items, based on the anticipated realization. The one or more programs generate a replenishment plan for the environment for the given time period, based on the ranking.

In some embodiments of the present invention, the quantifiable value is based on elements selected from the group consisting of: a proximity between the occurrences of the data representing consumable items coupled with the occurrences of the factors and frequency of the occurrences of the data representing consumable items coupled with the occurrences of the factors.

In some embodiments of the present invention, the one or more programs generate a product ranking factor score, for each of the consumable items. The one or more programs adjust the ranking, based on the product ranking factor score. Generating the product ranking score for each of the consumable may include: the one or more programs processing data from the structured and the unstructured data sources, where the processing includes identifying sentiments relevant to the consumable items; the one or more programs determining context for the sentiments relevant to the consumable items; the one or more programs aggregating sentiments for each consumable items of the consumable items referenced in the sentiments to determine a range of sentiments and a polarity between the sentiments for each consumable item to determine one or more product ranking factors for each consumable items; the one or more programs generating, by the one or more processors, a product ranking factor score for each consumable items of the consumable items referenced in the sentiments; and the one or more programs updating the data model with the product ranking factor scores.

In some embodiments of the present invention, the one or more programs determine the context for the sentiments relevant to the consumable items by applying a natural language processing algorithm.

In some embodiments of the present invention, the one or more programs also generate a product quality and safety score, for each of the consumable items. The one or more programs adjust the ranking, based on the product quality and safety score. In some embodiments of the present invention, the one or more programs generate the product quality and safety score, by: analyzing structured and unstructured data referenced by the data model to identify references to the consumable, wherein the analyzing comprises extracting data relevant to product quality standards and safety standards for the consumable items; obtaining public data via an Internet connection to publicly available data sources, wherein the public data comprises current quality information and current safety information related to the consumable items; and utilizing the public data and the product quality standards and safety standards for the consumable items to generate a product quality and safety score, for each of the consumable items.

In some embodiments of the present invention, the one or more programs select the publicly available data sources from the group consisting of: government websites, public social media posts, and published news.

In some embodiments of the present invention, the one or more programs generating the replenishment plan for the environment for the given time period includes the one or more programs generating a shopping list, for review by a user, based on the ranked candidate products.

In some embodiments of the present invention, the one or more programs generating the replenishment plan for the environment for the given time period includes the one or more programs automatically generating and executing an order including all candidate products or candidate products above a pre-defined rank.

Referring now to FIG. 9, a schematic of an example of a computing node, which can be a cloud computing node 10. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove. In an embodiment of the present invention, the cognitive server 130 (FIG. 1), the computing node 145 (FIG. 1), and the cognitive inventory replenishment agent 110 (FIG. 1) can each be understood as a cloud computing node 10 (FIG. 9) and if not a cloud computing node 10, then one or more general computing nodes that include aspects of the cloud computing node 10.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 9, computer system/server 12 that can be utilized as cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples include, but are not limited to: microcode, device drivers, redundant processing units, external disk drive arrays, RAID systems, tape drives, and data archival storage systems, etc.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs). Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter). Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

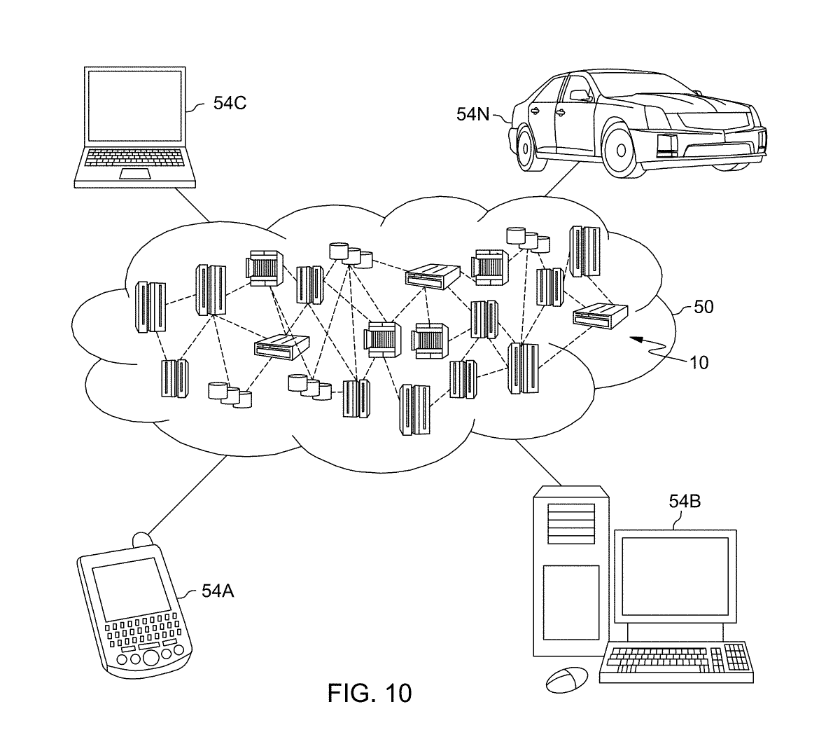

Referring now to FIG. 10, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 10 and cloud computing environment 50 can communicate with any type of computerized device over any type of network and/or network addressable connection (e.g., using a web browser).

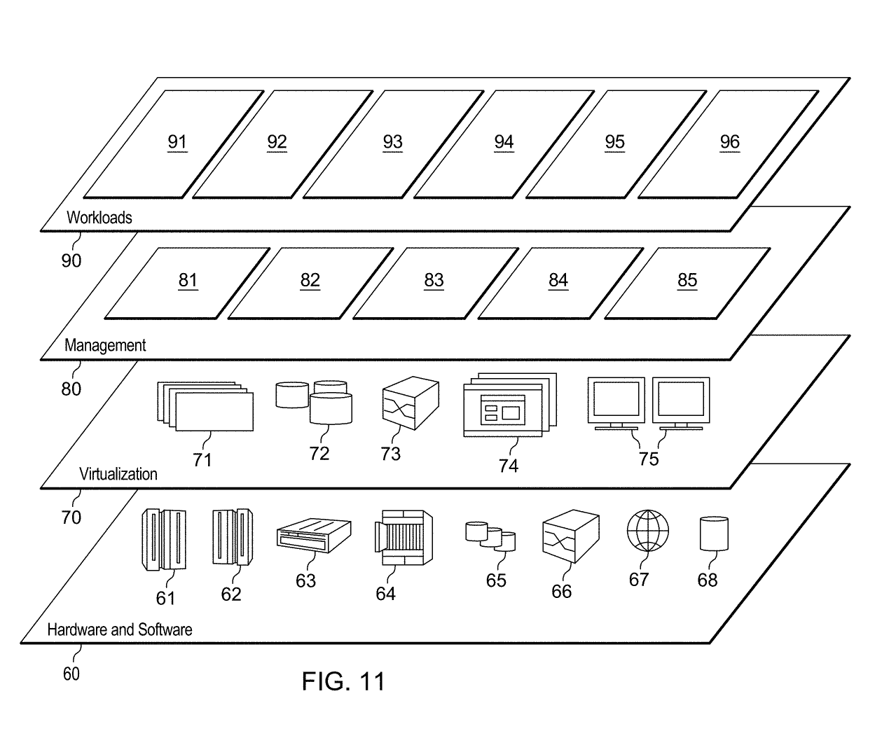

Referring now to FIG. 11, a set of functional abstraction layers provided by cloud computing environment 50 (FIG. 10) is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and performing a cognitive multiple factor analysis to generate an inventory replenishment plan 96.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components and/or groups thereof.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description, but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method, comprising:
generating, by one or more processors, a data model for a given environment, the data model comprising a listing of consumable items utilized in the environment and structured and unstructured data sources relevant to the consumable items utilized in the environment;
machine learning, by the one or more processors, factors related to supply and demand for the consumable items, based on ingesting structured and unstructured data from the data sources indicated in the data model and extracting occurrences of data representing consumable items coupled with occurrences of the factors;
generating, by the one or more processors, correlations between one or more of the consumable items utilized and one or more of the factors, wherein the generating comprises assigning each correlation a quantifiable value;
updating, by the one or more processors, the data model with the correlations;
obtaining, by the one or more processors, for a future given time period, a request for replenishment of the consumable items for the environment;
determining, by the one or more processors, an anticipated realization of the factors in the correlations, in the given time period, based on ingesting structured and unstructured data from the data sources indicated in the data model and extracting indicators of the factors in the correlations;
ranking, by the one or more programs, the consumable items, based on the anticipated realization; and
generating, by the one or more programs, a replenishment plan for the environment for the given time period, based on the ranking.

2. The computer-implemented method of claim 1, wherein the quantifiable value is based on elements selected from the group consisting of: a proximity between the occurrences of the data representing consumable items coupled with the occurrences of the factors and frequency of the occurrences of the data representing consumable items coupled with the occurrences of the factors.

3. The computer-implemented method of claim 1, further comprising:
generating, by the one or more processors, a product ranking factor score, for each of the consumable items; and
adjusting, by the one or more processors, the ranking, based on the product ranking factor score.

4. The computer-implemented method of claim 3, wherein generating the product ranking score for each of the consumable items comprises:
processing, by the one or more processors, data from the structured and the unstructured data sources, wherein the processing comprises identifying sentiments relevant to the consumable items;
determining, by the one or more processors, context for the sentiments relevant to the consumable items;
aggregating, by the one or more processors, sentiments for each consumable items of the consumable items referenced in the sentiments to determine a range of sentiments and a polarity between the sentiments for each consumable item to determine one or more product ranking factors for each consumable items;
generating, by the one or more processors, a product ranking factor score for each consumable items of the consumable items referenced in the sentiments; and
updating, by the one or more processors, the data model with the product ranking factor scores.

5. The computer-implemented method of claim 4, wherein determining the context for the sentiments relevant to the consumable items comprises applying a natural language processing algorithm.

6. The computer-implemented method of claim 1, further comprising:
generating, by the one or more processors, a product quality and safety score, for each of the consumable items; and
adjusting, by the one or more processors, the ranking, based on the product quality and safety score.

7. The computer-implemented method of claim 6, wherein generating the product quality and safety score, for each of the consumable items comprises:
analyzing, by the one or more processors, structured and unstructured data referenced by the data model to identify references to the consumable, wherein the analyzing comprises extracting data relevant to product quality standards and safety standards for the consumable items;
obtaining, by the one or more processors, public data via an Internet connection to publicly available data sources, wherein the public data comprises current quality information and current safety information related to the consumable items; and
utilizing, by the one or more processors, the public data and the product quality standards and safety standards for the consumable items to generate a product quality and safety score, for each of the consumable items.

8. The computer-implemented method of claim 7, wherein the publicly available data sources are selected from the group consisting of: government websites, public social media posts, and published news.

9. The computer-implemented method of claim 1, wherein generating the replenishment plan for the environment for the given time period comprises:
generating, by the one or more processors, a shopping list, for review by a user, based on the ranked candidate products.

10. The computer-implemented method of claim 1, wherein generating the replenishment plan for the environment for the given time period comprises:
automatically generating and executing, by the one or more processors, an order comprising: all candidate products or candidate products above a pre-defined rank.

11. A computer program product comprising:
a computer readable storage medium readable by one or more processors and storing instructions for execution by the one or more processors for performing a method comprising:
generating, by the one or more processors, a data model for a given environment, the data model comprising a listing of consumable items utilized in the environment and structured and unstructured data sources relevant to the consumable items utilized in the environment;
machine learning, by the one or more processors, factors related to supply and demand for the consumable items, based on ingesting structured and unstructured data from the data sources indicated in the data model and extracting occurrences of data representing consumable items coupled with occurrences of the factors;
generating, by the one or more processors, correlations between one or more of the consumable items utilized and one or more of the factors, wherein the generating comprises assigning each correlation a quantifiable value;
updating, by the one or more processors, the data model with the correlations;
obtaining, by the one or more processors, for a future given time period, a request for replenishment of the consumable items for the environment;
determining, by the one or more processors, an anticipated realization of the factors in the correlations, in the given time period, based on ingesting structured and unstructured data from the data sources indicated in the data model and extracting indicators of the factors in the correlations;
ranking, by the one or more programs, the consumable items, based on the anticipated realization; and
generating, by the one or more programs, a replenishment plan for the environment for the given time period, based on the ranking.

12. The computer program product of claim 11, wherein the quantifiable value is based on elements selected from the group consisting of: a proximity between the occurrences of the data representing consumable items coupled with the occurrences of the factors and frequency of the occurrences of the data representing consumable items coupled with the occurrences of the factors.

13. The computer program product of claim 11, the method further comprising:
generating, by the one or more processors, a product ranking factor score, for each of the consumable items; and
adjusting, by the one or more processors, the ranking, based on the product ranking factor score.

14. The computer program product of claim 13, wherein generating the product ranking score for each of the consumable items comprises:
processing, by the one or more processors, data from the structured and the unstructured data sources, wherein the processing comprises identifying sentiments relevant to the consumable items;
determining, by the one or more processors, context for the sentiments relevant to the consumable items;
aggregating, by the one or more processors, sentiments for each consumable items of the consumable items referenced in the sentiments to determine a range of sentiments and a polarity between the sentiments for each consumable item to determine one or more product ranking factors for each consumable items;
generating, by the one or more processors, a product ranking factor score for each consumable items of the consumable items referenced in the sentiments; and
updating, by the one or more processors, the data model with the product ranking factor scores.

15. The computer program product of claim 14, wherein determining the context for the sentiments relevant to the consumable items comprises applying a natural language processing algorithm.

16. The computer program product of claim 11, further comprising:
generating, by the one or more processors, a product quality and safety score, for each of the consumable items; and
adjusting, by the one or more processors, the ranking, based on the product quality and safety score.

17. The computer program product of claim 16, wherein generating the product quality and safety score, for each of the consumable items comprises:
analyzing, by the one or more processors, structured and unstructured data referenced by the data model to identify references to the consumable, wherein the analyzing comprises extracting data relevant to product quality standards and safety standards for the consumable items;
obtaining, by the one or more processors, public data via an Internet connection to publicly available data sources, wherein the public data comprises current quality information and current safety information related to the consumable items; and
utilizing, by the one or more processors, the public data and the product quality standards and safety standards for the consumable items to generate a product quality and safety score, for each of the consumable items.

18. The computer program product of claim 1, wherein generating the replenishment plan for the environment for the given time period comprises:
generating, by the one or more processors, a shopping list, for review by a user, based on the ranked candidate products.

19. The computer-implemented method of claim 1, wherein generating the replenishment plan for the environment for the given time period comprises:
automatically generating and executing, by the one or more processors, an order comprising: all candidate products or candidate products above a pre-defined rank.

20. A system comprising:
a memory;
one or more processors in communication with the memory;
program instructions executable by the one or more processors via the memory to perform a method, the method comprising:
generating, by the one or more processors, a data model for a given environment, the data model comprising a listing of consumable items utilized in the environment and structured and unstructured data sources relevant to the consumable items utilized in the environment;
machine learning, by the one or more processors, factors related to supply and demand for the consumable items, based on ingesting structured and unstructured data from the data sources indicated in the data model and extracting occurrences of data representing consumable items coupled with occurrences of the factors;
generating, by the one or more processors, correlations between one or more of the consumable items utilized and one or more of the factors, wherein the generating comprises assigning each correlation a quantifiable value;
updating, by the one or more processors, the data model with the correlations;
obtaining, by the one or more processors, for a future given time period, a request for replenishment of the consumable items for the environment;
determining, by the one or more processors, an anticipated realization of the factors in the correlations, in the given time period, based on ingesting structured and unstructured data from the data sources indicated in the data model and extracting indicators of the factors in the correlations;
ranking, by the one or more programs, the consumable items, based on the anticipated realization; and
generating, by the one or more programs, a replenishment plan for the environment for the given time period, based on the ranking.
